(19) United States
(12) Patent Application Publication
(10) Pub. No.: US 2010/0326975 A1
(43) Pub. Date: Dec. 30, 2010

(54) METHOD AND APPARATUS FOR HEATING DEVICES OF A MINERAL MATERIAL PROCESSING UNIT AND A MINERAL MATERIAL PROCESSING UNIT

(75) Inventors: Sami Palo, Tampere (FI); Reijo Kankaanpaa, Tampere (FI); Pasi Pohjola, Tampere (FI)

Correspondence Address: OLIFF & BERRIDGE, PLC, P.O. BOX 320850, ALEXANDRIA, VA, 22320-4850, US

(73) Assignee: METSO Minerals, Inc., Helsinki (FI)

(21) Appl. No.: 12/918,428

(22) PCT Filed: Feb. 20, 2009
(86) PCT No.: PCT/FI09/50140

§ 371 Date: Sep. 8, 2010

(30) Foreign Application Priority Data
Feb. 22, 2008 (FI) 20085163

(51) Int. Cl. H05B 1/00

(52) U.S. Cl. 219/201

(57) ABSTRACT

A method and an apparatus for heating devices of a mineral material processing unit, said devices in said method being heated with electric heating means, whereby said devices are heated with heating means attached to or in the immediate vicinity of parts getting into contact with the feed material, and/or said devices are heated with heating means attached to or substantially in the immediate vicinity of parts most essential for the cold starting of said devices. The invention further relates to a mineral material processing unit.

The present invention relates to heating of devices of a mineral material processing unit. More precisely, the invention relates to a method and an apparatus for heating by using electric heating means, to a material processing unit equipped with this kind of an apparatus, and to an electric heating element to be used as heating means in said apparatus.

It is known in the art to heat feeding devices of mineral materials or the bottom thereof with different solutions in situations, where it is required by the optimal treatment of the material to be fed to a processing device of mineral materials, like a crusher.

The need for heating occurs especially for example in freezing conditions or in situations, where the feed material—for example clay—becomes viscose when it is moist, and thus sticks to the bottom and sides of the feeder. In that case the heating of the feeding device facilitates loosening of the feed material from the bottom and sides of the feeder, thus preventing agglomeration of the feed material to the forward end of the feeder, where the feed material is fed to.

In freezing or damp conditions, the moist feed material sticks on the surfaces of the devices, forming a very dense and solid mass, that causes blocking of the processing devices of mineral materials like crushers, screens, feeders and other auxiliary devices like conveyors and separation and feed hoppers used in the crushing and screening process. It is extremely difficult to remove this dense and solid mass from the surfaces of the devices. By heating the processing devices of mineral materials, blocking of the devices in freezing and damp conditions can be prevented.

Also starting of the crushers and screening devices, for example, can cause need for heating, because starting problems and increasing risk of defects and damages can be caused by the cold conditions.

Traditionally, the bottom of a feeding device is heated by using electric resistors or hydraulic oil heated when using actuators belonging to the hydraulic system, or by leading hot exhaust gas through pipes mounted to the bottom of the feeder to the open air from the diesel motor used as power source. Various known solutions are discussed on general basis e.g. in the European patent publication EP 0 879 651.

Electric heating resistors or elements used for heating the feeding devices are traditionally attached to the bottom plate of the feeding device for heating the bottom of the device or to the frame of the feeder to heat the whole frame of the feeder. One solution of this type is disclosed in the Korean publication KR 2004-0056931.

A problem with this kind of a solution of prior art is, among others, that the surfaces coming into contact with the feed material are slowly heated, whereby they are not warm until the heating elements and the parts between these surfaces have warmed up and started to transfer heat to the surfaces against the feed material. In addition, the solutions of prior art require much electric energy for the heating, and cause a risk of fire when heating the feeder surfaces up to high temperatures. Also the surface treatment material used for the devices can burn off due to the high temperature, causing corrosion problems.

In the solution in accordance with the present invention, electric heating means like heating resistors and/or elements are positioned substantially in connection with those surfaces of devices of a mineral material processing unit, like for example of a feeder device feeding material to a crusher, like vibration feeder, screen etc, that come into contact with the material to be fed to the processing unit.

In this description, the term processing unit of mineral material refers to any processing unit suitable for processing materials, like a feeder, belt conveyor, crusher, screen or any other corresponding device transferring, refining or sorting materials. Also processing units for recirculation of material are included in this group. Material to be processed can be totally or partly mineral material. Mineral material can be ore, broken rock or gravel, different recirculated construction wastes like concrete, bricks or asphalt.

With this kind of positioning of heating means, the heat can be directed precisely where it is needed, in other words, as close as possible to the material to be fed/crushed, without big consumption of electric power, fire risk or other corresponding problems of solutions of prior art.

The solution in accordance with the invention is advantageously implemented by means of heating panels equipped with a resistor or a resistance mat vulcanized inside an elastic material like silicone rubber. The heating panels are formed of an intermediate plate positioned between an upper plate and a lower plate, in other words a so called washer plate, a recess or cutting being formed within the edges of the washer plate for the silicon vulcanized resistor or resistance mat. This kind of a heating panel can be easily attached e.g. to the lower surface of a wear plate of a feeder, in other words to the surface that is opposite to the surface setting against the feed material. Said silicone resistor can also be advantageously shaped, and especially bent to an arch, whereby the heating panels can be advantageously used in different parts of a mineral material processing unit, where heating is needed e.g. in cold conditions when starting the processing unit and its auxiliary devices. Those are e.g. bearings of crushers, vibration aggregates of vibratory feeders, conveyors and components of driving devices of screening units.

More precisely, the method according to the present invention is characterized by what is stated in the characterizing part of Claim 1, the apparatus according to the invention is characterized by what is stated in the characterizing part of Claim 5, and the processing unit of mineral materials according to the invention is characterized by what is stated in the characterizing part of Claim 11.

The invention will be described by way of example in more detail in the following with reference to the enclosed drawings, wherein

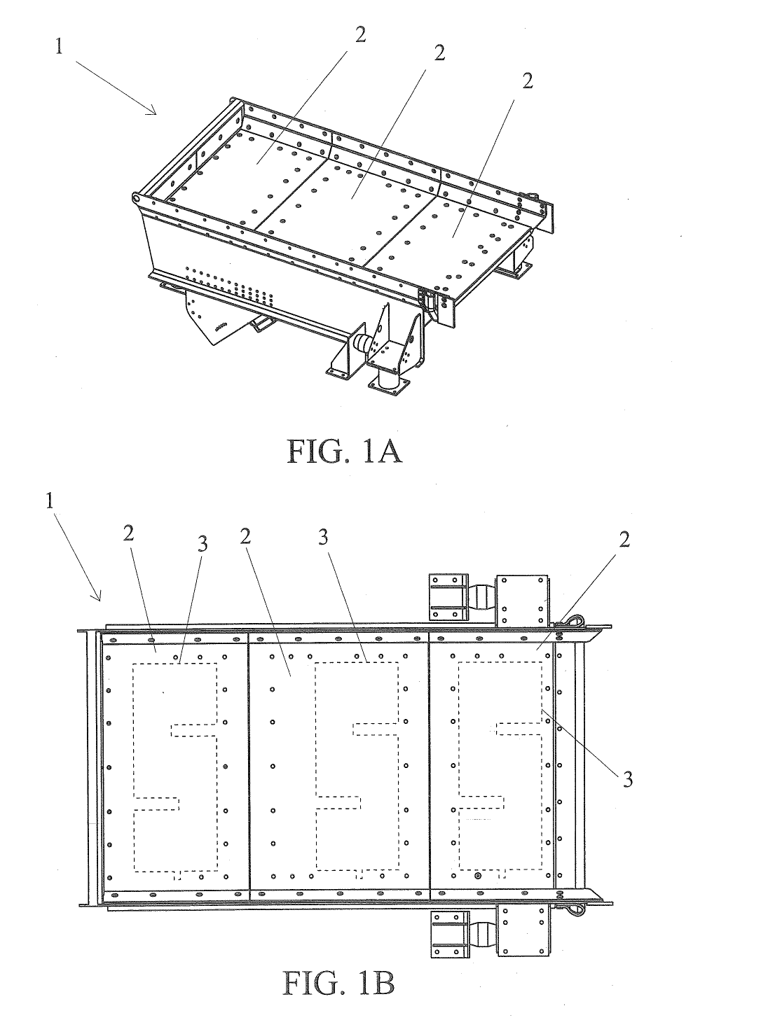

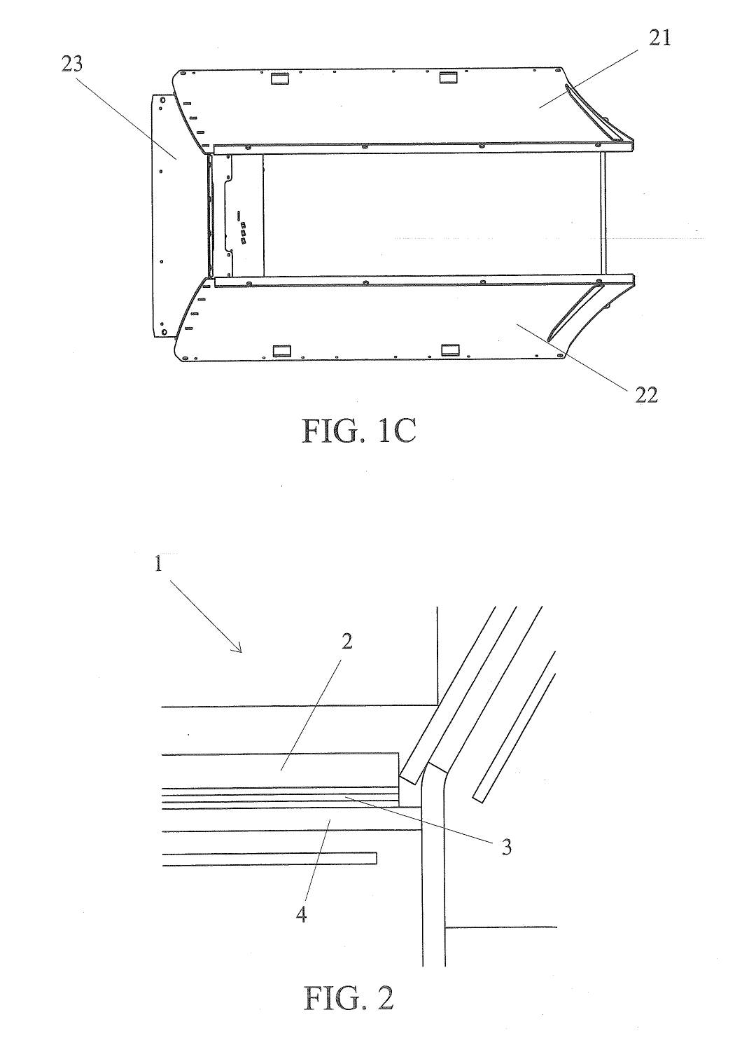

FIGS. 1A and 1B show one solution of the present invention applied to a vibratory feeder of a processing unit of mineral material,

FIG. 1C shows side walls of the vibratory feeder of FIGS. 1A and 1B,

FIG. 2 shows schematically an enlarged partial section of the vibratory feeder of FIGS. 1A and 1B,

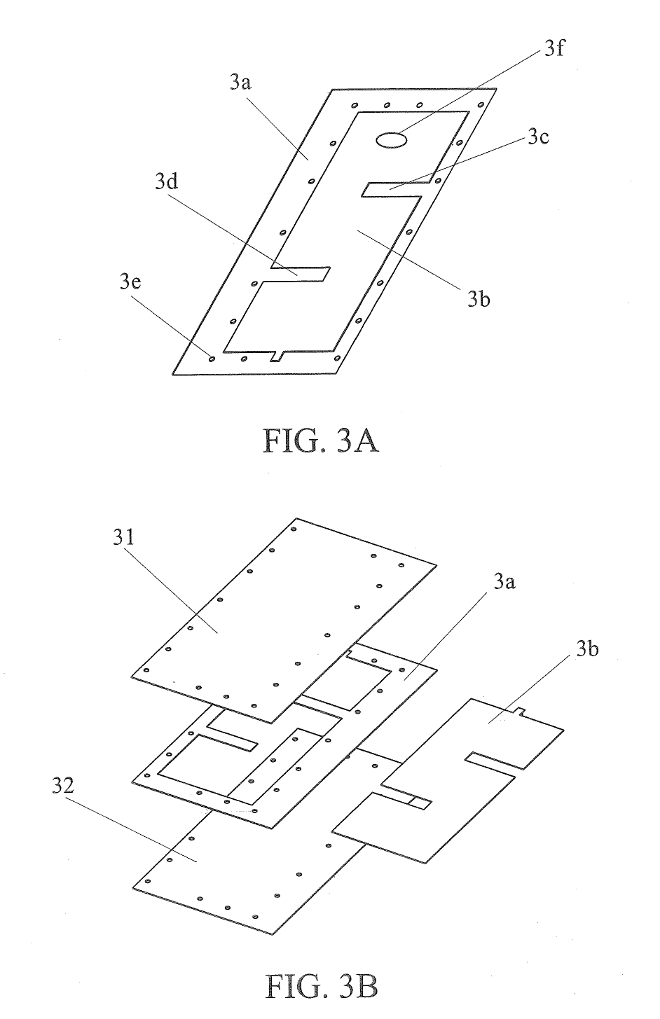

FIG. 3A shows a silicon resistor layer of a heating panel used in FIGS. 1A, 1B and 2,

FIG. 3B is an exploded view of essential components of one heating panel according to the invention,

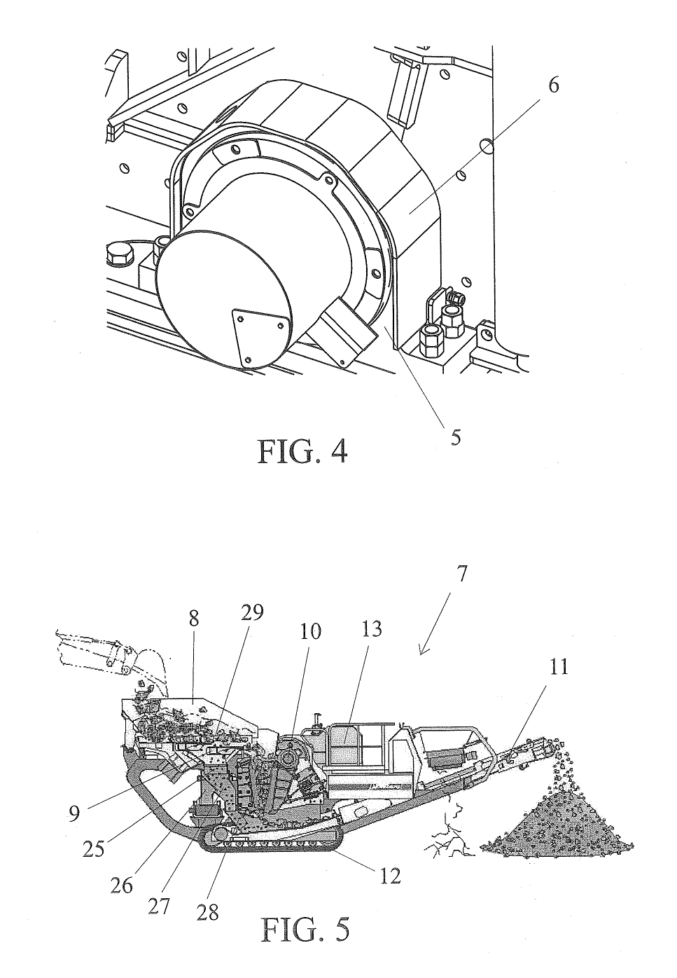

FIG. 4 shows one solution according to the invention, applied to heating of crusher bearings, and

FIG. 5 shows one essential application of the solutions according to the invention.

FIGS. 1A and 1B show a body 1 of a vibratory feeder, said body comprising wear plates 2, onto which feed material is fed e.g. by using an excavator bucket. The vibratory feeder transfers material towards an open edge of the vibratory feeder, from where the material is led e.g. to a crusher to be ground. The vibratory effect of the vibratory feeder tends to separate from the feed material the fine-grained portion that is removed from the feed material e.g. by means of a screen, before the feed material is led to the crusher.

The vibratory feeder usually also comprises side walls 21, 22 shown in FIG. 1C and an end wall 23, said side and end walls forming a feed hopper for the vibratory feeder and being attached to the supporting structure surrounding the frame 1 of the vibratory feeder. These side walls do not vibrate along with the vibratory feeder. Surfaces of the side walls are equipped with wear plates, feed material flowing along said wear plates or being compiled on the vibratory feeder. Thus, the wear plates of the side walls of the vibratory feeder are one essential application of the heating solution in accordance with the present invention, whereby the heating panels can be attached to the back surfaces of the wear plates of the side walls for heating the wear surfaces thereof.

In the example shown in FIGS. 1A and 1B, the vibratory feeder comprises three successively positioned wear plates 2, a heating panel 3 being attached to the lower surface of each according to the invention. Portions indicated by a dashed line in FIG. 1B present silicone rubber resistors inside the heating panels 3.

Positioning of the heating panels 3 in the frame 1 of the vibratory feeder is in more detail illustrated in FIG. 2, showing the position of the heating panel 3 between the wear plate 2 and a support plate 4 forming a part of the frame. By setting the heating panel 3 in this way in connection with the wear plate 2, the effect of the heating panel can be efficiently directed to the wear plate, whereby the eventual freezing of the feed material onto the surface of the wear plate can be efficiently prevented. The schematic drawing of FIG. 2 also shows the laminated construction of the heating panel 3, consisting of a surface plate, bottom plate and a resistance layer positioned between them, said resistance layer consisting of a silicone resistor and a so called washer plate surrounding it. The washer plate and silicone resistor are in more detail illustrated in FIG. 3. The surface and bottom plate and the washer plate can be made of metal, like steel. The manufacturing material can also be e.g. aluminium, zinc copper, copper, plastic, stone, concrete. Silicone resistor and washer plate are almost freely formable in the manufacturing phase.

In the example of FIG. 2, the orientation of the heating effect of the heating panel 3 to the wear plate can be improved e.g. by thermally isolating it from the support plate 4 by placing a separate thermal insulation layer between the support plate and the heating panel, which can be implemented e.g. by changing the bottom plate of the heating panel 3 into a different material than the surface plate thereof.

FIG. 3A shows an intermediate layer of a heating panel advantageously used in the solution in accordance with the invention, consisting of a washer plate 3a and a silicon resistor mat 3b. The silicone resistor mat 3b has substantially the same thickness as the washer plate 3a. The silicone resistor mat 3b is placed in the opening formed in the washer plate 3a, whereby the washer plate protects and supports the silicone resistor between the surface plates of the heating panel. The washer plate 3b comprises two projections 3c and 3d providing support constructions extending to the centre portions of the resistor mat. The projections of the washer plate provide that the silicone resistor withstands impacts subjected to the wear plate and the weight of the wear plate. In addition, the washer plate 3b comprises fixing holes 3e, for attaching the aggregate formed by the resistor mat and the washer plate with bolts to the surface and bottom plate for forming a heating panel, said fixing holes also being provided for attaching the heating panel between the wear part 2 and the support plate 4.

The quantity and form of the projections 3c, 3d is not limited to the case described by the above mentioned example. Their form and quantity can be freely chosen based on the respective purpose of use. In addition or alternatively, the projections can also be located e.g. as separate patch-like areas 3f surrounded by the resistor mat.

With this kind of a heating panel of the invention, the silicone resistor mat 3b inside the panel can be efficiently protected, thus preventing the heating resistor from damaging in demanding conditions of processing units of different materials.

In the solution in accordance with the invention, the heating panel 3 can advantageously be attached to the part of the mineral material processing unit to be heated by means of a glued surface formed on top of the upper surface of the heating panel. This kind of a glued surface provides a solid attachment of the heating element 3 e.g. to the wear plate 2, which improves transmission of heat from the element to the wear plate. Alternatively, the heating panel 3 can be attached to the part to be heated by means of fixing bolts mounted through the fixing holes 3e.

The solution in accordance with the invention can also be carried out so, that the upper plate of the heating panel 3 can be replaced with a part of the mineral material processing unit to be heated, for example with the wear plate 2. In this way the heating element of the heating panel 3 is directly attached to the part to be heated, which further enhances the heating.

In FIG. 3B, the essential parts of the heating panel are shown, to illustrate the mutual attachment of the parts. From top downwards, the heating panel comprises an upper plate 31, below a washer plate 3a and a heating element 3b on the same plane and lowermost a lower plate 32. In this figure, the heating element 3b is illustrated adjacent to the washer plate 3a, whereas it in the assembled heating panel is located inside the washer plate, as shown in FIG. 3A.

FIG. 4 shows one solution in accordance with the invention for heating bearings of a crusher, like for example a jaw crusher, which is one of the most essential heating objects when starting the crusher cold, because the bearings are of significant meaning for the use of the crusher. In the solution of the figure, a heating panel 6 bent according to the shape of the outer surface of the bearing box has been attached to the surface of the bearing box 5 of the crusher bearing. Thus, the bearings of the crusher can be heated before starting in cold conditions, which essentially reduces eventual bearing damages.

Heating panels 6 can be correspondingly attached in connection with other operating devices of the mineral material processing unit for heating them prior to starting the processing unit in cold conditions. Examples of other similar applications in the processing unit include, among others, heating of hydraulic pipes. In that case the heating panel can have a form of a pipe or a half pipe. An advantage of this application is that a viscose liquid in the pipe installation can be quickly heated, and the circulation in the pipes is accelerated. Also a loading point of a conveyor, hatches, oil tanks, control devices, safety devices like stairs, working platforms and footbridges, can be heated by using a heating panel in accordance with the invention.

FIG. 5 shows a mineral material processing unit most essentially benefiting from the solution in accordance with the invention, that is a mobile crushing plant 7. This kind of a mobile crushing plant of prior art usually comprises in the material flow direction, among others, a vibratory feeder 8, screening unit 9, crusher 10, conveyor 11 for the crushed material, material pockets and dividing chutes 25, 27 and hoppers 26, 28, and a feeding box 29 of the screen. In addition, the mobile crushing plant comprises means 12 for moving the crushing plant, like for example rolls, feet or wheels. The crushing plant also comprises a power unit 13 for driving the operating devices of the plant and for moving the plant.

These mobile crushing plants 7 are very often used in cold and freezing conditions, whereby the problems mentioned in the beginning of the description part often are very familiar to these aggregates.

The solution in accordance with the invention is not limited to the solution shown in the example of the figures, where the electric heating means are attached to the wear plate of feeding device of the mineral material processing unit, or essentially in the immediate vicinity thereof. The solution in accordance with the invention can also be implemented to any device of a mineral material processing unit, the parts of which get into contact with the material to be fed to the processing unit. An example of this is an excavator bucket, to which heating elements in accordance with the invention can be attached. Essential from the point of view of the invention is that the electric heating means are attached to or in close vicinity of those parts that get into contact with the material to be fed into the processing unit.

In addition to the feeding devices described in the figures, examples of other most essential applications of the solution in accordance with the invention include, among others, side edges of screen deck constructions, discharge cams, surfaces of lower hoppers and feed boxes of screen units. One potential application is also locating the heating means between wear parts and control devices of a crusher and support surfaces thereof.

The silicone resistor of the heating panel used in the solution in accordance with the invention is formed by setting a resistance cord or a glass-fibre insulated resistance wire between two silicone mat layers. The material of the silicone mat can be silicone rubber or some other elastic and heating resistant material, like for example natural rubber. Operation voltage of a heating panel equipped with such a silicone resistor ranges usually from 12V to 460V, and a maximum surface power is abt. 5 kW/m². The thickness of the heating panel ranges from abt. 0.7 to 3 mm, and it can be bent with max. bending radius of abt. 50 mm. Maximum achievable operation temperature with the heating panel depends on the materials to be used. It is preferably abt. +220° C. Electrically conductive materials like copper, nickel-chrome or copper-nickel compound can be used as resistor element. As insulating and surrounding materials for the heating conductor of the resistor element also other materials with corresponding properties can be used, like PTFE coated grating, glass yarn fabric or quartz fiber fabric can be used.

1. A method for heating devices of a mineral material processing unit, said devices in said method being heated with electric heating means, which heating means are attached to or substantially in the immediate vicinity of parts getting into contact with the feed material, and/or to or substantially in the immediate vicinity of parts most essential for the cold starting of said devices, wherein the electric heating means comprise a heating panel comprising a washer plate, in which washer plate is formed a space for a heating resistor or resistor mat connected with an elastic material.

2. A method in accordance with claim 1, wherein the parts of mineral material processing unit to be heated comprise a wear plate of a feeding device, sides of screen deck constructions of a screen unit, discharge cams of the screen unit, chutes, surfaces of lower hoppers of the screen unit and a feed box of the screen unit, as well as bearings of a crusher, bearings of vibratory devices, gears, pipes.

3. A method in accordance with claim 1, wherein the heating means are thermally isolated at least on the side opposite to the side setting against or towards the part to be heated.

4. A method in accordance with claim 1, wherein the mineral material processing unit is a crusher, feeder, screen or a mobile crushing plant.

5. An apparatus for heating devices of a mineral material processing unit, said apparatus comprising electrical heating means for heating said devices, which heating means are attached to or substantially in the immediate vicinity of the parts of said devices getting into contact with the feed material, and/or to or substantially in the immediate vicinity of parts most essential for the cold starting of said devices, wherein the electric heating means comprise a heating panel comprising a washer plate, in which washer plate is formed a space for a heating resistor or resistor mat connected with an elastic material.

6. An apparatus in accordance with claim 5, wherein the parts of the mineral material processing unit to be heated comprise a wear plate of a feeding device, sides of a screen deck of a screen unit, discharge cams of the screen unit, chutes, surfaces of lower hoppers of the screen unit and the feed box of the screen unit.

7. An apparatus in accordance with claim 5, wherein the heating means are thermally isolated at least on the side opposite to the side setting against or towards the part to be heated.

8. An apparatus in accordance with claim 5, wherein the heating panel further comprises an upper surface plate and a lower surface plate.

9. An apparatus in accordance with claim 5, wherein the elastic material is silicone or rubber.

10. An apparatus in accordance with claim 5, wherein the mineral material processing unit is a crusher, feeder, conveyor, screen or a mobile crushing plant.

11. A mineral material processing unit, wherein the processing unit is equipped with an apparatus in accordance with claim 5.

12. A processing unit in accordance with claim 11, wherein the processing unit is a crushing plant.

13. A processing unit in accordance with claim 12, wherein the crushing plant is a mobile crushing plant comprising feet, wheels or rolls for moving the crushing plant.

14. A processing unit in accordance with claim 11, wherein the processing unit is a feeder, screen or conveyor.
